(19) United States
(12) Patent Application Publication
(10) Pub. No.: US 2007/0241194 A1
(43) Pub. Date: Oct. 18, 2007

(54) Data exchange method and system based on continuous machine-readable code

(75) Inventors: Chia-Ching Lin, Chaojhou Township (TW); Li-Ying Kuo, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 11/727,432

(22) Filed: Mar. 27, 2007

(30) Foreign Application Priority Data
Apr. 17, 2006 (TW) 095113616

(51) Int. Cl. G06K 7/10

(52) U.S. Cl. 235/462.01

(57) ABSTRACT

A data exchange method and system based on continuous machine-readable code, which transfers data between a first device and a second device. The first device has a display, and the second device has an image extractor. The first device divides data to be transferred into a plurality of blocks and converts the blocks into corresponding machine-readable codes. The second device uses the image extractor to continuously capture the machine-readable codes displayed on the display of the first device, respectively decodes the machine-readable codes to thereby obtain the blocks, and concatenates the blocks to thus obtain the data.

### BACKGROUND OF THE INVENTION

1. Field of the Invention

The invention relates to the technical field of data transfer and, more particularly, to a data exchange method and system based on continuous machine-readable code.

2. Description of Related Art

Now that wireless communications are in widespread use, a cellphone is considered a necessity by modern people. The cellphone typically contains a digital camera module to thereby additionally function as a digital camera. In addition, the cellphone with the digital camera module may be equipped with a two-dimensional barcode capturing function such that a user can apply the information captured from the two-dimensional barcode to many extensive services. For example, the information associated with a food item, such as the production place, the distribution date, the expiration date, and so on, can be searched over the Internet by an identification code corresponding to a captured two-dimensional barcode indicated on the food item. Accordingly, many cellphones have a built-in two-dimensional barcode auto-recognition module because such an application is very suitable for all applications of cellphones.

In addition, many cellphones have the built-in digital camera module and a function of exchanging data with a personal computer (PC). Accordingly, a cellphone can download various firmware items from the PC to update the internal protocols or software when the protocols for wireless communications are increasingly complex and the cellphone applications become versatile, such as in uploading photos captured by the digital camera module to the PC, and downloading a telephone list or personal schedule to the internal memory through the function of exchanging data with the PC to thereby avoid the input inconvenience to the cellphone.

Typically, the cellphone uses a wireless communication technology, such as Bluetooth, infrared or wireless local area network (WLAN), or a USB interface to transfer data to/from the PC, which requires corresponding hardware modules and thus increases the manufacturing costs. For example, if the Bluetooth communication technology is used, the PC and the cellphone are each required to be equipped with the Bluetooth module for data transfer. If the USB interface is used, a USB cable is needed. Accordingly, an improvement on data transfer between the cellphone and the PC is desired.

### SUMMARY OF THE INVENTION

An object of the invention is to provide a data exchange method and system based on continuous machine-readable code, which can easily transfer data between the cellphone and the PC.

Another object of the invention is to provide a data exchange method and system based on continuous machine-readable code, which can use the currently existing hardware to transfer data between the cellphone and the PC to accordingly provide an additional function to the cellphone with the digital camera module.

In accordance with one aspect of the present invention, there is provided a data exchange method based on a continuous machine-readable code, which transfers data between a first device and a second device. The first device has a display, and the second device has an image extractor. The method includes: (A) using the first device to segment data to be transferred into a plurality of blocks; (B) using the first device to convert the blocks into corresponding machine readable codes and to cyclically display the machine readable codes on the display; (C) using the image extractor of the second device to continuously capture the machine readable codes displayed on the display of the first device and respectively decode the machine readable codes captured to thereby obtain the blocks; and (D) using the second device to concatenate the blocks to thus obtain the data.

In accordance with another aspect of the present invention, there is provided a data exchange system based on continuous machine-readable code, which includes a first device and a second device. The first device has a display and a machine-readable code generator. The first device segments data to be transferred into a plurality of blocks, uses the machine readable code generator to convert the blocks into corresponding machine readable codes, and cyclically displays the machine readable codes on the display. The second device has an image extractor and a machine-readable code decoder. The second device uses the image extractor to continuously capture the machine readable codes displayed on the display of the first device, uses the machine readable code decoder to respectively decode the machine readable codes captured to thereby obtain the blocks, and concatenates the blocks to thus obtain the data.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a data exchange system based on continuous machine-readable code in accordance with the invention;

FIG. 2 is a block diagram of a first device and a second device in accordance with the invention;

FIG. 3 is a flowchart of using a first device to display machine-readable codes in accordance with the invention;

FIG. 4 is a flowchart of using a second device to capture and decode machine-readable codes in accordance with the invention;

FIG. 5 is a schematic diagram of dividing data to be transferred into a plurality of blocks and adding a header in each of the blocks in accordance with the invention;

FIG. 6 is another flowchart of using a first device to display machine-readable codes in accordance with the invention; and

FIG. 7 is another flowchart of using a second device to capture and decode machine-readable codes in accordance with the invention.

### DETAILED DESCRIPTION OF THE PREFERRED EMBODIMENT

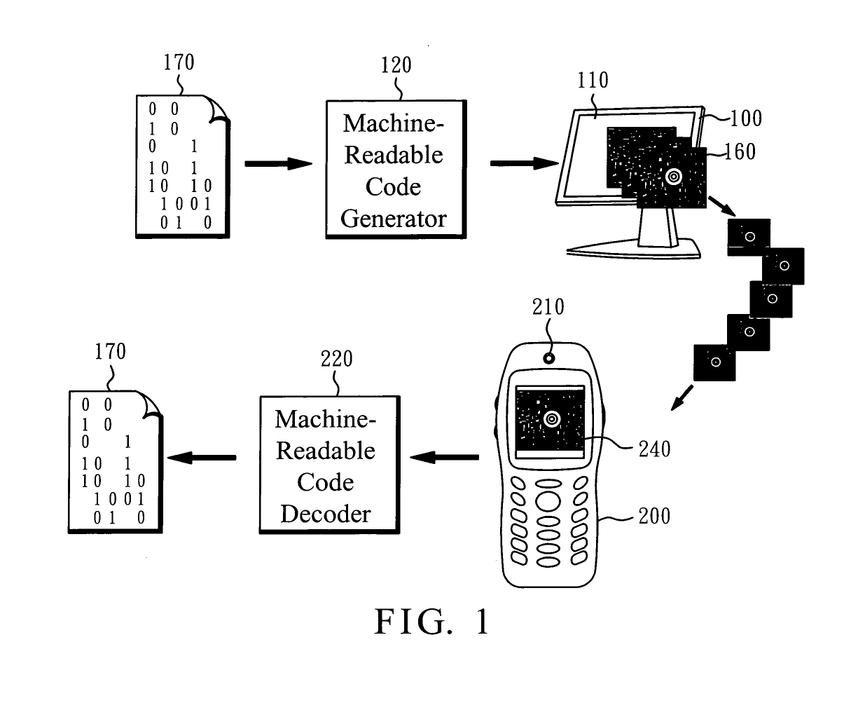

FIG. 1 is a schematic view of a data exchange system based on continuous machine-readable code in accordance with the invention. As shown in FIG. 1, the system includes a first device 100 and a second device 200. The first device 100 can be a PC, notebook, PDA, camera cellphone, or any device with a display. The second device 200 can be a PC, notebook, PDA, camera cellphone, or any device with an image extractor. In this embodiment, the first device 100 is a PC, and the second device 200 is a camera cellphone.

As shown in FIG. 1, the first device 100 displays data 170 to be transferred on an embedded display 110 in a form of machine-readable codes 160. The second device 200 uses an embedded image extractor 210 to capture the machine-readable codes 160 displayed on the display 110 of the first device 100, thereby achieving the data exchange purpose.

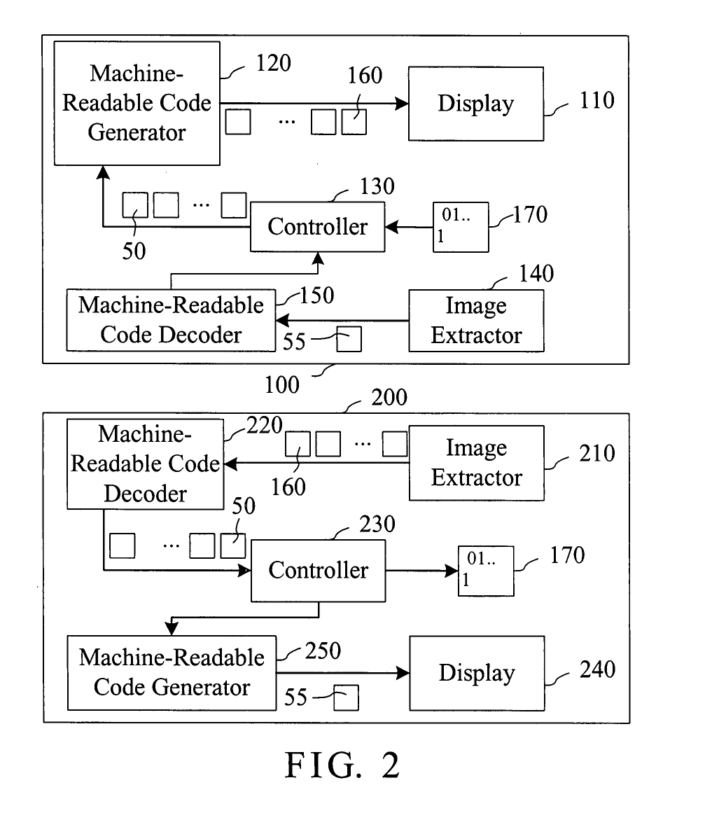

FIG. 2 is a block diagram of the first device 100 and the second device 200 in accordance with the invention. As shown in FIG. 2, the first device 100 includes the display 110, a machine-readable code generator 120 and a controller 130. The first device 100 can also include an image extractor 140 and a machine-readable code decoder 150. The controller 130 segments the data 170 to be transferred into a plurality of blocks 50, and controls the generator 120 to convert the blocks 50 into the machine-readable codes 160 and, as shown in FIG. 1, cyclically display the codes 160 on the display 110.

The second device 200 includes the image extractor 210, a machine-readable code decoder 220 and a controller 230. The second device 200 can also include a display 240 and a machine-readable code generator 250. The image extractor 210 continuously captures the machine-readable codes 160 displayed on the display 110 of the first device 100. The machine-readable code decoder 220 respectively decodes the machine-readable codes 160 to thereby obtain the blocks 50. The controller 230 concatenates the blocks to thus obtain the data 170.

Further, a function of automatic data exchange can be achieved by the image extractor 140 and machine-readable code decoder 150 of the first device 100 and the display 240 and machine-readable code generator 250 of the second device 200. For example, when the data 170 is obtained by the second device 200, the second device 200 can use the machine-readable code generator 250 to generate an indicative machine-readable code 55 for ending the transfer and to display the code 55 on the display 240. In this case, the image extractor 140 captures the code 55, and the machine-readable code decoder 150 decodes the code 55 captured to accordingly generate a transfer ending control signal to quit displaying the codes 160 on the display 110.

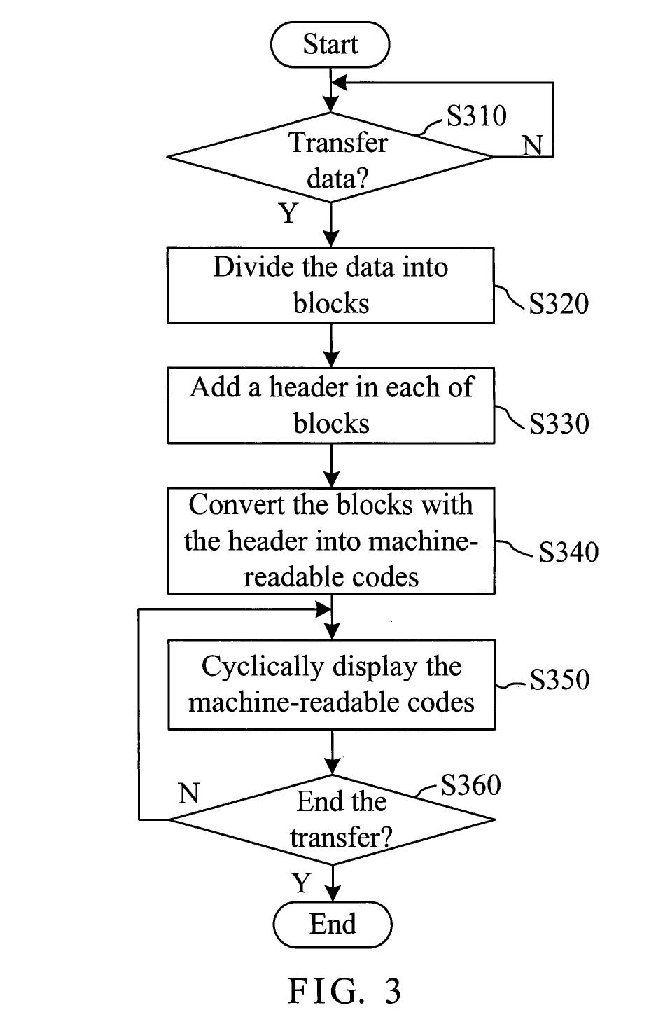

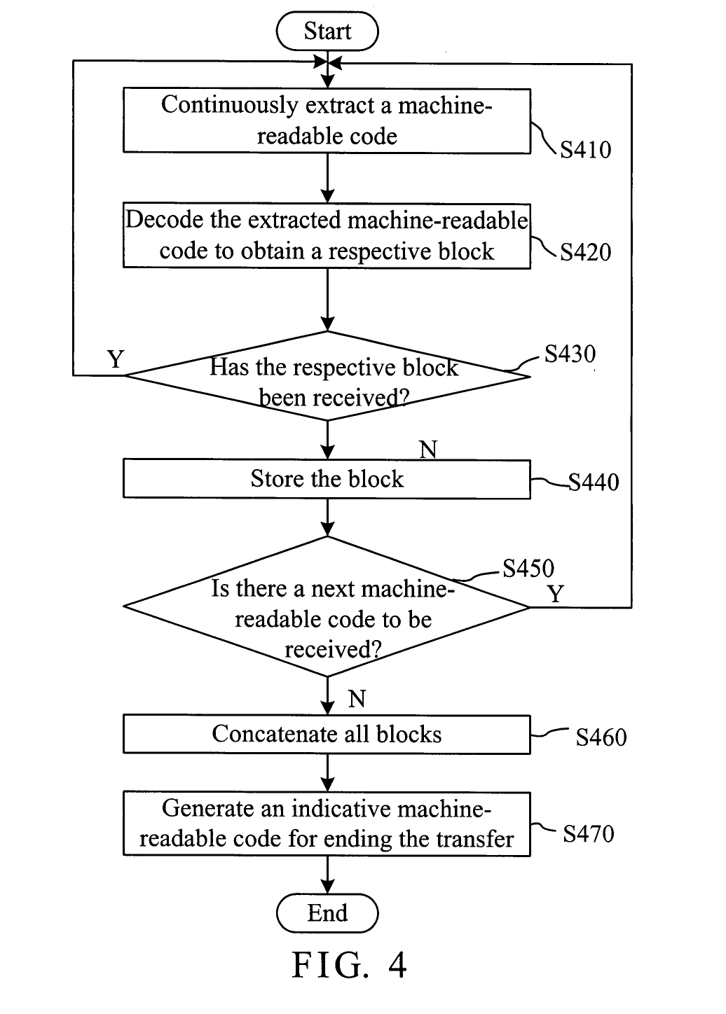

FIG. 3 is a flowchart of using the first device 100 to display machine-readable codes in accordance with the invention. FIG. 4 is a flowchart of using the second device 200 to capture and decode machine-readable codes in accordance with the invention. Upon the flowcharts of FIGS. 3 and 4, the data is sent from the first device 100 to the second data 200.

As shown in FIG. 3, in step S310, the controller 130 determines if the data 170 is to be transferred; if yes, step S320 is executed, and if not, step S310 is executed. In step S320, the first device 100 uses the controller 130 to segment the data 170 into the blocks 50 because the amount of the data 170 is greater than the capacity of a carry unit for one of the machine-readable codes 160.

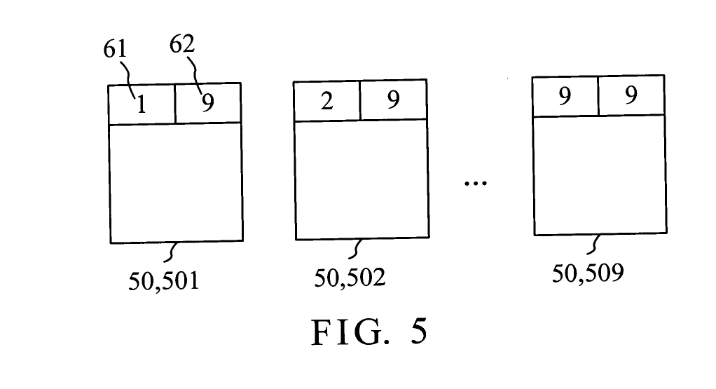

In step 330, the controller 130 adds a header in each of the blocks 50. As shown in FIG. 5, the data 170 is segmented into the blocks 501 to 509, and the header added in each of the blocks includes the information of respective orders 61 and total block number 62. Accordingly, when cyclically displaying on the display 110, the codes 160 corresponding to each of the blocks 50 can be distinct.

In step S340, the first device 100 uses the generator 120 to convert the blocks 50 into the machine-readable codes 160. In step S350, the first device 100 cyclically displays the machine-readable codes 160 on the display 110.

In step S410, the second device 200 uses the image extractor 210 to continuously capture a machine-readable code 160 currently displayed on the display 110 of the first device 100, frame by frame. In step S420, the second device 200 uses the decoder 220 to decode the machine-readable code captured to thereby obtain a respective block 50.

In step S430, the controller 230 determines whether the respective block 50 has been received based on the order information contained in the header of the respective block 50 to; if not, step S440 is executed; and if yes, step 410 is executed.

In step S440, the respective block 50 is stored. In step S450, the controller 230 determines whether the codes 160 have been completely received based on the total block number information contained in the header of the respective block 50; if yes, step S460 is executed; and if not, step 410 is executed.

In step S440, the second device 200 concatenates the respective blocks 50 to obtain the data 170. In step S470, the second device 200 generates an indicative machine-readable code 55 and to display the code 55 on the display 240 for ending the transfer between the devices 100 and 200.

In step S360, the first device 100 uses the image extractor 140 to capture the code 55 and the machine-readable code decoder 150 to decode the code 55 captured to accordingly generate the transfer ending control signal. The controller 130 quits displaying the codes 160 on the display 110 based on the transfer ending control signal.

In other embodiments, in step 470, the second device 200 generates an indicative signal for ending the transfer between the devices 100 and 200. The indicative signal can be a prompt voice for the user to end the second device 200 receiving the codes 160 when hearing the prompt voice.

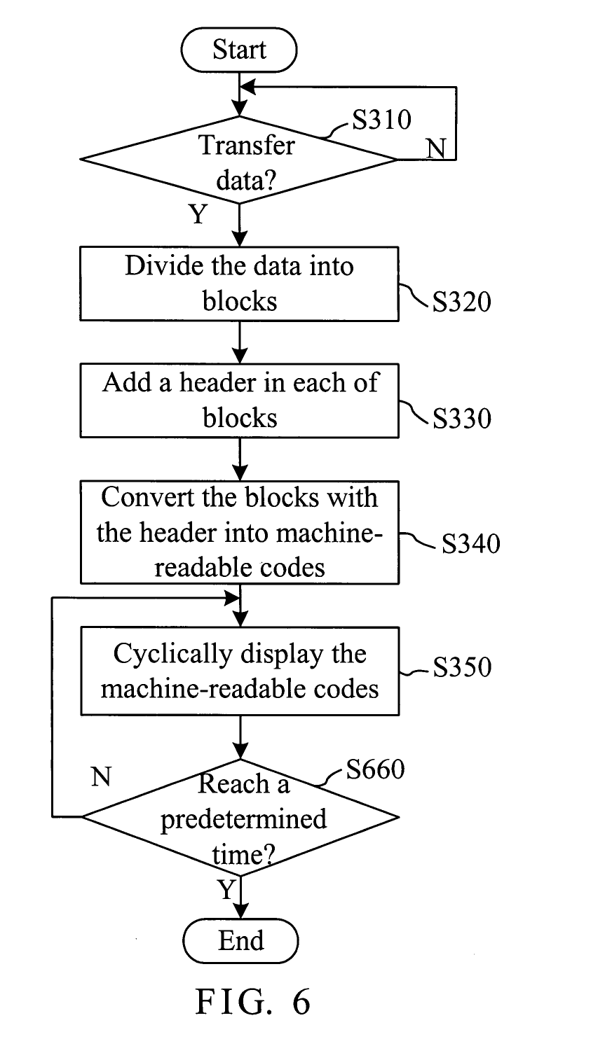

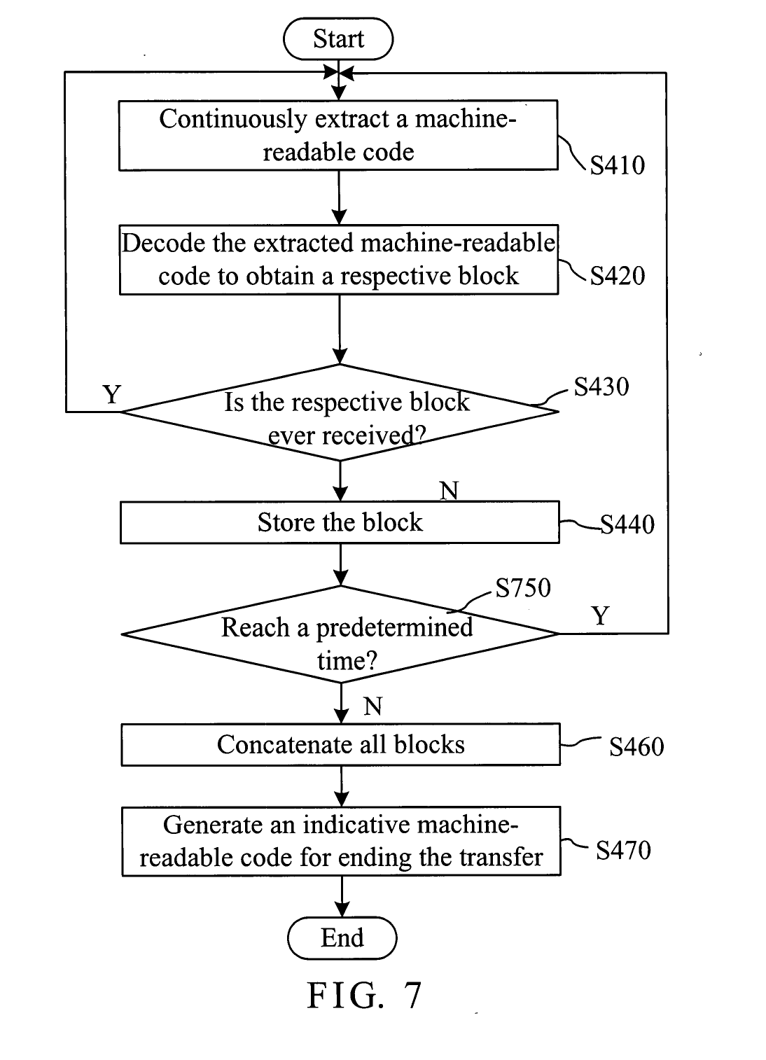

FIG. 6 is another flowchart of using the first device 100 to display machine-readable codes in accordance with the invention. FIG. 7 is another flowchart of using the second device 200 to capture and decode machine-readable codes with respect to the first device 100 of FIG. 6. The flowchart of FIG. 6 is as same as that of FIG. 3 except in step S660, and the same steps are thus not described repeatedly. In step S660, the first device 100 determines if a predetermined time is reached; if not, step S350 is executed; and if yes, the controller 130 quits displaying the machine-readable codes on the display 110. If the display 110 takes one second to display one code 160 and there are nine codes in total, it takes nine seconds for displaying nine codes 160. In this case, the display 110 displays the nine codes three times as the predetermined time is set to 27 seconds. Similarly, the flowchart of FIG. 7 is the same as that of FIG. 4 except in step S750, and the same steps are thus not described repeatedly. In step S750, the second device 200 determines if a predetermined time is reached; if not, step s410 is executed; and if yes, step S460 is executed.

In this embodiment, the machine-readable codes are preferred as a two-dimensional barcode. The decoders 150 and 220 and the generators 120 and 250 are preferred as hardware modules. However, in other embodiments, the devices 150, 220, 120 and 250 also can be software modules, and accordingly a typical cellphone with the digital camera function can use the method of the invention to transfer data, which provides the typical cellphone with the additional function without increasing any additional hardware cost.

In view of the foregoing, it is known that the two-dimensional barcode in the prior art is pre-produced, which carries the fixed information and is not suitable for data transfer between two devices. The present invention segments data into a plurality of machine-readable codes, i.e., the first device 100 dynamically generates the machine-readable codes. Next, the second device 200 captures the information carried by the codes. Thus, a data transfer between two devices by the machine readable codes is achieved. In addition, the data amount carried by the two-dimensional barcode in the prior is limited, but the invention can overcome the limited data amount while data transfer between two devices can be carried out. Further, the invention can be applied without increasing any hardware cost. Namely, data transfer between a cellphone and a PC can be easily processed without providing a USB cable to connect to the USB interface or installing a wireless communication module (such as a Bluetooth module), which increases the additional functions of the cellphone.

Although the present invention has been explained in relation to its preferred embodiment, it is to be understood that many other possible modifications and variations can be made without departing from the spirit and scope of the invention as hereinafter claimed.

What is claimed is:

1. A data exchange method based on continuous machine-readable code, which transfers data between a first device with a display and a second device with an image extractor, the method comprising the steps of:
(A) using the first device to segment data to be transferred into a plurality of blocks;
(B) using the first device to convert the blocks into machine-readable codes correspondingly and to cyclically display the machine-readable codes on the display;
(C) using the image extractor of the second device to continuously capture the machine-readable codes displayed on the display of the first device and respectively decode the machine-readable codes captured to thereby obtain the blocks; and
(D) using the second device to concatenate the blocks to obtain the data.

2. The method as claimed in claim 1, wherein each of the blocks in step (B) has a header including a respective order and a total block number.

3. The method as claimed in claim 2, wherein step (C) further comprises:
(C1) using the image extractor of the second device to capture a machine-readable code currently displayed on the display of the first device;
(C2) decoding the machine-readable code captured to thereby obtain a respective block, and determining if the respective block is received in accordance with the respective order of the header of the respective block;
(C3) storing the respective block when step (C2) considers that the respective block is not received, and determining if a next machine-readable code is to be received in accordance with the total block number; and
(C4) ending the transfer between the first device and the second device when step (C3) considers that there is no more machine-readable code to be received, and otherwise executing step (C1).

4. The method as claimed in claim 3, further comprising the steps between step (C) and step (D) as the first device further comprises an image extractor and the second device further comprises a display:
(E) using the second device to generate an indicative machine-readable code and to display the indicative machine-readable code on the display of the second device; and
(F) using the image extractor of the first device to capture the indicative machine-readable code, and decoding the indicative machine-readable code to accordingly generate a transfer ending control signal to stop displaying the machine-readable codes on the display of the first device.

5. The method as claimed in claim 1, wherein the image extractor of the second device captures the machine-readable codes displayed on the display of the first device in a frame by frame manner.

6. The method as claimed in claim 1, wherein the machine-readable codes are a two-dimensional barcode.

7. The method as claimed in claim 1, wherein the first device is one selected from a PC, a notebook, a PDA and a camera cellphone, and the second device is one selected from a PC, a notebook, a PDA and a camera cellphone.

8. The method as claimed in claim 3, further comprising the step between step (C) and step (D):
(G) using the second device to generate an indicative signal for ending the transfer and to quit the image extractor of capturing the machine-readable codes displayed on the display of the first device.

9. The method as claimed in claim 8, wherein the indicative signal is a prompt voice.

10. The method as claimed in claim 2, wherein step (C) further comprises:
(C5) using the image extractor of the second device to capture a machine-readable code currently displayed on the display of the first device;
(C6) decoding the machine-readable code captured to thereby obtain a respective block, and in accordance with the respective order of the header of the respective block to determine if the respective block is received;
(C7) storing the respective block when step (C6) considers that the respective block is not received, and further determining if a predetermined time is reached; and
(C8) ending the transfer between the first device and the second device when step (C7) decides that the predetermined time is reached, and otherwise executing step (C5).

11. A data exchange system based on continuous machine-readable code, comprising:
a first device having a display and a machine-readable code generator, which segments data to be transferred into a plurality of blocks, uses the machine-readable code generator to convert the blocks into machine-readable codes correspondingly, and cyclically displays the machine-readable codes on the display; and
a second device having an image extractor and a machine-readable code decoder, which uses the image extractor to continuously capture the machine-readable codes displayed on the display of the first device, uses the machine-readable code decoder to respectively decode the machine-readable codes captured to thereby obtain the blocks, and concatenates the blocks to thus obtain the data.

12. The system as claimed in claim 11, wherein each of the blocks has a header containing a respective order and a total block number.

13. The system as claimed in claim 12, wherein the second device determines which the blocks are not received for being stored based on the respective orders of the headers from the blocks obtained by decoding the machine-readable codes.

14. The system as claimed in claim 13, wherein the second device determines whether a next machine-readable code is to be received based on the total block number and captures the next machine-readable code when received in that manner, and otherwise the transfer between the first device and the second device is ended.

15. The system as claimed in claim 14, wherein the first device further comprises an image extractor and the second device further comprises a display, such that the second device generates an indicative machine-readable code when the machine-readable codes are completely received and displays the indicative machine-readable code on the display of the second device, and the image extractor of the first device captures and decodes the indicative machine-readable code to accordingly generate a transfer ending control signal to stop displaying the machine-readable codes on the display of the first device.

16. The system as claimed in claim 11, wherein the image extractor of the second device captures the machine-readable codes displayed on the display of the first device in a frame by frame manner.

17. The system as claimed in claim 11, wherein the machine-readable codes are a two-dimensional barcode.

18. The system as claimed in claim 11, wherein the first device is one selected from a PC, a notebook, a PDA and a camera cellphone, and the second device is one selected from a PC, a notebook, a PDA and a camera cellphone.

19. The system as claimed in claim 13, wherein the second device determines whether a next machine-readable code is to be received based on the total block number and further determines whether a predetermined time is reached when the next machine-readable code to be received is determined, and finally quits receiving the machine-readable codes when the predetermined time is reached.
